(19) United States
(12) Patent Application Publication
(10) Pub. No.: US 2026/0238799 A1
(43) Pub. Date: Aug. 13, 2026

(54) CTU SLICE-BASED PARALLEL PROCESSING IN VIDEO CODING

(71) Applicant: MEDIATEK INC., Hsinchu City (TW)

(72) Inventors: Lulin CHEN, San Jose, CA (US); Olena CHUBACH, San Jose, CA (US); Yu-Wen HUANG, Hsinchu City (TW)

(21) Appl. No.: 19/155,981

(22) PCT Filed: Feb. 18, 2024
(86) PCT No.: PCT/CN2024/077356

§ 371 Date: Aug. 13, 2025

Related U.S. Application Data
(60) Provisional application No. 63/485,558, filed on Feb. 17, 2023.
(60) Provisional application No. 63/584,512, filed on Sep. 22, 2023.
(60) Provisional application No. 63/584,921, filed on Sep. 25, 2023.

(51) Int. Cl. H04N 19/174; H04N 19/129; H04N 19/167; H04N 19/436; H04N 19/70

(52) U.S. Cl. CPC H04N 19/174; H04N 19/129; H04N 19/167; H04N 19/436; H04N 19/70

(57) ABSTRACT

A method for coding a video picture as slices of coding tree units (CTUs) is provided. A video coder receives data to be encoded or decoded as a current picture. The current picture is partitioned into one or more slices. The video coder signals or receives parameters of a slice of the current picture. When the slice is a rectangular slice, the slice parameters indicate a top-left CTU of the slice, a width of the slice, and a height of the slice. When the slice is a raster scan slice, the slice parameters indicate a starting CTU and an ending CTU of the slice. The CTUs of the slice are coded and packaged in a network abstraction layer (NAL) unit to be transported or stored. The NAL unit has a size that is defined based on a size of the slice and no other slice.

### CROSS REFERENCE TO RELATED PATENT APPLICATION(S)

The present disclosure is part of a non-provisional application that claims the priority benefit of U.S. Provisional Patent Application Nos. 63/485,558, 63/584,512, and 63/584,921, filed on 17 Feb. 2023, 22 Sep. 2023, and 25 Sep. 2023, respectively. Contents of above-listed applications are herein incorporated by reference.

### TECHNICAL FIELD

The present disclosure relates to methods of coding video pictures by parallel processing of slices.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs). The coded video data is organized into network abstraction layer (NAL) units, each of which is a packet that contains an integer number of bytes for transport or storage.

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The encoded video data of a slice may be exclusively contained in a single NAL unit for delivery and decoding. The size of the NAL unit may be defined based on the size of the slice.

The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide methods for coding a video picture as slices. A video coder receives data to be encoded or decoded as a current picture. The current picture is partitioned into one or more slices, each slice partitioned as coding tree units (CTUs). The video coder signals or receives parameters of a slice of the current picture. When the slice is a rectangular slice, the slice parameters indicate a top-left CTU of the slice, a width of the slice, and a height of the slice. When the slice is a raster scan slice, the slice parameters indicate a starting CTU and an ending CTU of the slice.

In some embodiments, the video coder may signal or receive a flag as a syntax element in a bitstream to indicate whether the slice is a rectangular slice or a raster scan slice. The video coder may process the CTUs in two or more different slices of the current picture in parallel. The video coder may perform wavefront parallel processing (WPP) by processing different groups (e.g., rows) of CTUs of a slice in parallel with different delays. In some embodiments, the video coder may derive a right boundary and a left boundary for the slice based on the slice parameters. In some embodiments, when the slice is a raster scan slice, the right boundary of the slice is derived based on a width of the current picture, particularly when the raster scan slice is rectangular shaped. The current picture may also include rectangular slices that are adjacent but not aligned.

The CTUs of the slice are coded and packaged in a network abstraction layer (NAL) unit to be transported or stored. In some embodiments, the NAL unit has a size that is defined based on a size of the slice and no other slice. The NAL unit transports data for the slice and no other slice, and the different slices of the current picture are transported by different NAL units.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIGS. 1A-B illustrate raster scan slices and rectangular slices.

FIG. 2 shows parallel processing threads operating to encode or decode multiple slices within a video picture.

FIG. 3 shows wavefront parallel processing (WPP) being applied within a slice of a video picture.

FIG. 4 illustrates a video picture that is divided into rectangular slices.

FIG. 5 illustrates a video picture that is divided into raster scan slices.

FIG. 6 illustrates an example video encoder that may implement raster scan and rectangular slices.

FIG. 7 illustrates portions of the video encoder that implement parallel processing for rectangular and raster scan slices.

FIG. 8 conceptually illustrates a process for encoding a video picture as rectangular or

raster scan slices.

FIG. 9 illustrates an example video decoder that may implement raster scan and rectangular slices.

FIG. 10 illustrates portions of the video decoder that implement parallel processing for rectangular and raster scan slices.

FIG. 11 conceptually illustrates a process for decoding a video picture as rectangular or raster scan slices.

FIG. 12 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

A slice partition may have slice boundary that impose constraints on coding tools in encoding and decoding processes, such as the processing of edge checking and neighbouring block availability checking, QP setting, CABAC initialization and loop filtering. Those constraints may be used by various applications and/or flexibility control, including for enabling a parallel processing structure.

### I. Raster Scan Slice and Rectangular Slice

For some embodiments, a CTU grid is a basic partition of a picture, and the CTUs of one slice are exclusively contained in one single NAL unit. In some embodiments, a slice may be specified as an integer number of CTUs ordered consecutively in the raster scan within a picture. Such a slice is referred to as a raster scan slice. In some embodiments, a slice may be specified as an integer number of consecutive complete CTU rows within a rectangular region of a picture. Such a slice is referred to as a rectangular slice. In some embodiments, a video picture may be partitioned into raster scan slices and/or rectangular slices.

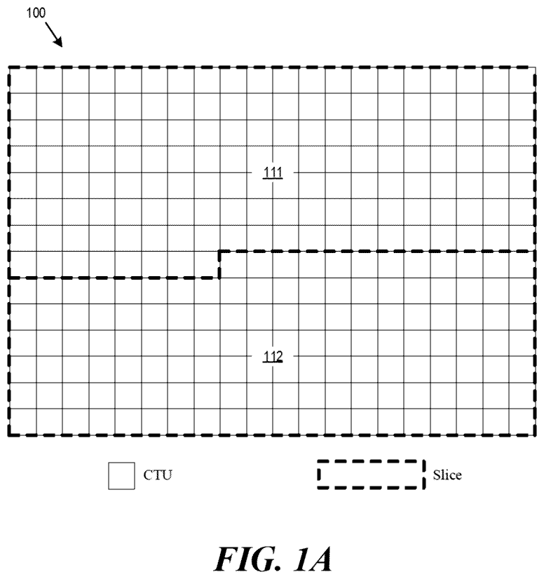

FIGS. 1A-B illustrate raster scan slices and rectangular slices. FIG. 1A illustrates a picture 100 partitioned into two (2) raster scan slices 111 and 112. A raster scan slice shape may or may not be rectangular. FIG. 1B illustrates the same picture 100 partitioned into four (4) rectangular slices 121-124. In the encoding and decoding process, CTUs contained in a slice (rectangular or raster scan) are in the raster scan order.

### II. Parallel Processing

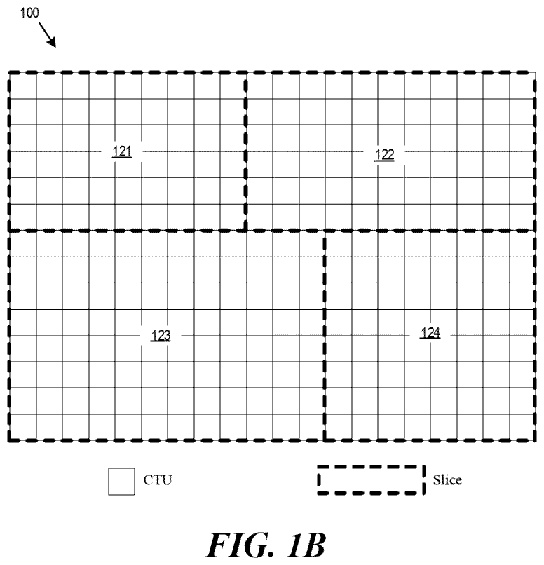

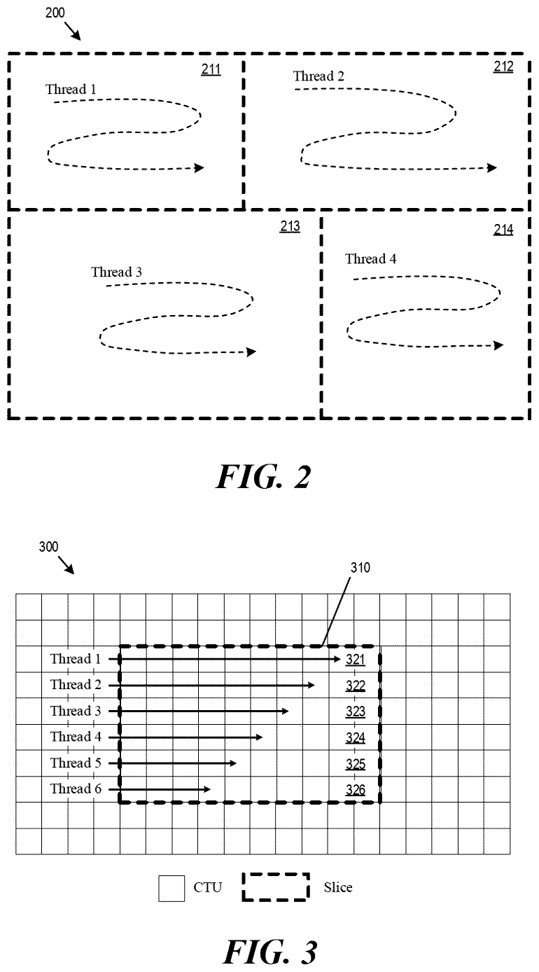

CTU-based block data video coding may be subject to slice boundary constraint and control. Multiple different partitions defined by slice boundaries (i.e., slices) within a picture may be processed by different parallel processing threads. FIGS. 2 and 3 conceptually illustrate parallel processing threads (the arrow lines) coding different parts of a video picture.

FIG. 2 shows an example in which four parallel processing threads (the arrow lines labeled as threads 1-4) are operating to encode or decode the four slices 211-214 within a video picture 200. In the example, the four slices 211-214 are rectangular slices.

FIG. 3 shows an example in which wavefront parallel processing (WPP) is applied within a slice 310 of a video picture 300. (The slice 310 may be one of multiple rectangular slices of the video picture 300. The slice 310 may also be the only slice of the video picture 300.) As illustrated, when parallel processing is performed, slice-specific processing threads 1-6 (the arrow lines) are applied to different CTU rows 321-326 of the slice 310. The processing threads 1-6 are assigned to different CTU rows. The parallel processing is conducted in a WPP manner (to accommodate logical dependencies of the already reconstructed CTUs), such that the threads 2-6 of the different CTU rows 322-326 start with different CTU delays relative to the processing thread 1 of the first (top-most) CTU row 321.

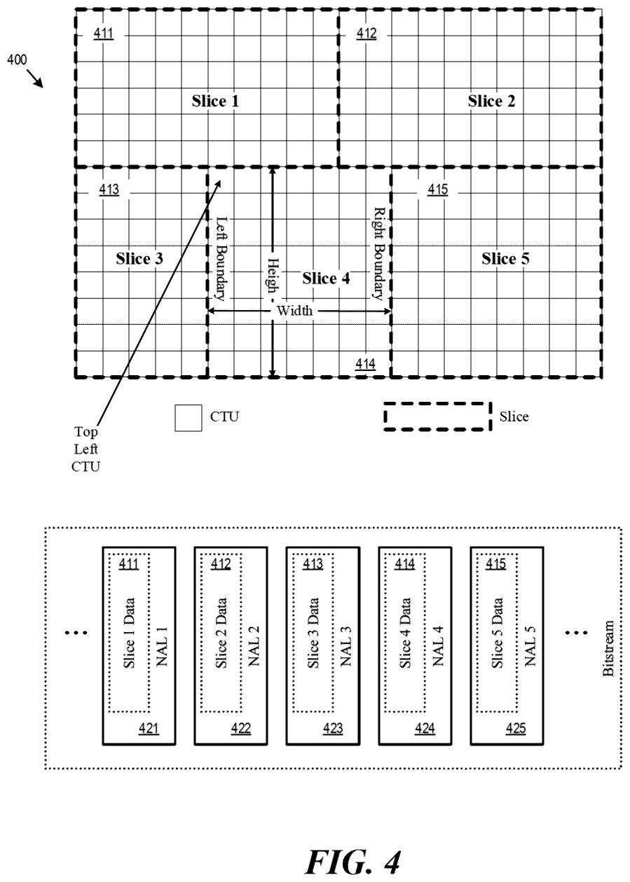

In some embodiments, slices of a video picture may be rectangular slices or raster scan slices. In some embodiments, a syntax element pps_rect_slice_flag is used to indicate whether a slice is a rectangular slice or raster scan slice. FIG. 4 illustrates a video picture 400 that is divided into rectangular slices 411-415 (labeled as slices 1 through 5). For a rectangular slice (pps_rect_slice_flag=1), the left and right boundaries are derived with the top-left CTU and the last CTU positions of the slice in units of CTBs. As an example, the figure shows the width and height of the rectangular slice 414 and its top-left CTU.

The data of the rectangular slices 411-415 are transported by NAL units 421-425, respectively and exclusively. For example, the NAL unit 423 transports slice data of only the slice 413 and no other slice, the NAL unit 424 transports the slice data of only the slice 414 and no other slice, etc.

In some embodiments, rectangular slices that are adjacent may not be aligned. In the example of FIG. 4, the slice 411 and the slice 414, though (vertically) adjacent, are not (horizontally) aligned. Similarly, the slice 412 and the slice 414 are also adjacent but not aligned. In other words, at least some of the left or right vertical boundaries of the rectangular slices 411, 412, or 414 may not span the entire height of the picture. (Though not illustrated, in some embodiments, top or bottom horizontal boundaries of a rectangular slice may not span the entire width of the picture.)

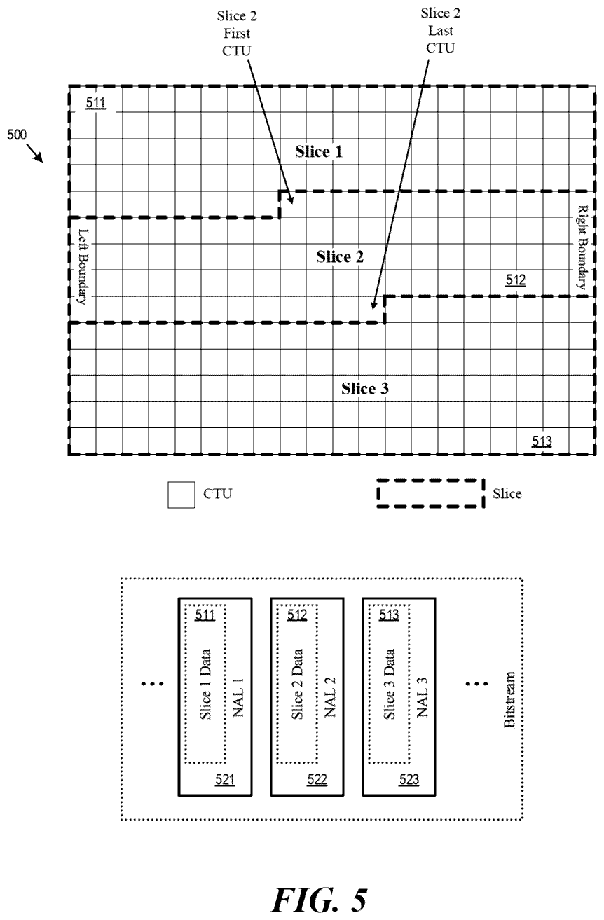

FIG. 5 illustrates a video picture 500 that is divided into raster scan slices 511-513 (slices 1 through 3). For a raster scan slice (pps_rect_slice_flag=0), the left and right boundaries are derived based on the first CTU position of the slice and the picture width in units of CTBs. As an example, the figure shows the first and last CTUs of the raster scan slice 512 and its left and right boundaries. Though not illustrated in the figure, a raster scan slice may have a rectangular shape.

The data of the raster scan slices 511-513 are transported by NAL units 521-523, respectively and exclusively. For example, the NAL unit 521 transports slice data of only the slice 511 and no other slice, the NAL unit 522 transports the slice data of only the slice 512 and no other slice, etc.

### III. Syntax Elements for Slices

In some embodiments, a video picture is not partitioned according to tiles, such that the tile partitions in the picture parameter set (PPS) or in the slice header (SH) are removed. Tile-based processing such as derivation process for neighbouring block availability, derivation process for quantization parameters, and deblocking filter process etc., are replaced by slice-based processing. In some embodiments, a CTU-based slice partitions of a picture are specified and signalled accordingly, e.g., for rectangular slices with the specified top-left CTU positions and width/height in units of CTUs in the PPS or in the SPS, and/or for raster scan slices with the specified syntax elements in a video coding standard such as VVC. For example, a syntax element sh_num_ctus_in_slice_minus1 replaces sh_num_ctus_in_tiles_minus1 in the SH. Syntax elements such as those for checking of left and right slice boundaries may be modified. Derivation for variables such as NumEntryPoints and NumCtusInCurrSlice may also be modified. Some examples of syntax elements modified so CTU-based slice partitions replace tiles are provided below:

sps_entropy_coding_sync_enabled_flag equal to 1 specifies that a specific synchronization process for context variables is invoked before decoding the CTU that includes the first CTB of a row of CTBs in each slice in each picture referring to the SPS, and a specific storage process for context variables is invoked after decoding the CTU that includes the first CTB of a row of CTBs in each slice in each picture referring to the SPS. sps_entropy_coding_sync_enabled_flag equal to 0 specifies that no specific synchronization process for context variables is required to be invoked before decoding the CTU that includes the first CTB of a row of CTBs in each slice in each picture referring to the SPS, and no specific storage process for context variables is required to be invoked after decoding the CTU that includes the first CTB of a row of CTBs in each slice in each picture referring to the SPS. When sps_entropy_coding_sync_enabled_flag is equal to 1, wavefront parallel processing (WPP) is enabled.

sps_entry_point_offsets_present_flag equal to 1 specifies that signalling for entry point offsets for slice-specific CTU rows could be present in the slice headers of pictures referring to the SPS. sps_entry_point_offsets_present_flag equal to 0 specifies that signalling for entry point offsets for slice-specific CTU rows are not present in the slice headers of pictures referring to the SPS.

sh_num_ctus_in_slice_minus1 plus 1, when present, specifies the number of CTUs in the slice. The value of sh_num_ctus_in_slice_minus1 shall be in the range of 0 to PicSizeInCtbs−1, inclusive. When not present, the value of sh_num_ctus_in_slice_minus1 shall be inferred to be equal to 0.

The variable NumCtusInCurrSlice specifies the number of CTUs in the current slice. The list CtbAddrInCurrSlice[i], for i ranging from 0 to NumCtusInCurrSlice−1, inclusive, specifies the picture raster scan address of the i-th CTB within the slice. The variable NumCtusInCurrSlice and the list CtbAddrInCurrSlice[i] are derived according to the following syntax (modified from existing syntax of VVC):

```
if( pps_rect_slice_flag ) {
  picLevelSliceIdx = sh_slice_address
  for( j = 0; j < CurrSubpicIdx; j++ )
    picLevelSliceIdx += NumSlicesInSubpic[ j ]
  NumCtusInCurrSlice = NumCtusInSlice[ picLevelSliceIdx ]
  for( i = 0; i < NumCtusInCurrSlice; i++ )
    CtbAddrInCurrSlice[ i ] = CtbAddrInSlice[ picLevelSliceIdx ][ i ]
} else {
  NumCtusInCurrSlice = 0
  for( ctbIdx = sh_slice_address; ctbIdx <= sh_slice_address + sh_num_ctus_in_slice_minus1; ctbIdx++ ) {
    CtbAddrInCurrSlice[ NumCtusInCurrSlice ] = ctbIdx
    NumCtusInCurrSlice++
    }
```

sh_slice_header_extension_data_byte[i] may have any value. Its presence and value do not affect the decoding process. The variable NumEntryPoints, which specifies the number of entry points in the current slice, may be derived as followed:

```
NumEntryPoints = 0
if( sps_entry_point_offsets_present_flag )
  for( i = 1; i < NumCtusInCurrSlice; i++ ) {
    ctbAddrY = CtbAddrInCurrSlice[ i ] / PicWidthInCtbsY
      prevCtbAddrY = CtbAddrInCurrSlice[ i − 1 ] / PicWidthInCtbsY
      if(( ctbAddrY != prevCtbAddrY && sps_entropy_coding_sync_enabled_flag ) )
        NumEntryPoints++
    }
```

sh_entry_offset_len_minus1 plus 1 specifies the length, in bits, of the sh_entry_point_offset_minus1[i] syntax elements. The value of sh_entry_offset_len_minus1 shall be in the range of 0 to 31, inclusive.

sh_entry_point_offset_minus1[i] plus 1 specifies the i-th entry point offset in bytes, and is represented by sh_entry_offset_len_minus1 plus 1 bits. The slice data that follow the slice header consists of NumEntryPoints+1 subsets, with subset index values ranging from 0 to NumEntryPoints, inclusive. The first byte of the slice data is considered byte 0. When present, emulation prevention bytes that appear in the slice data portion of the coded slice NAL unit are counted as part of the slice data for purposes of subset identification. Subset 0 consists of bytes 0 to sh_entry_point_offset_minus1[0], inclusive, of the coded slice data, subset k, with k in the range of 1 to NumEntryPoints−1, inclusive, consists of bytes firstByte[k] to lastByte[k], inclusive, of the coded slice data with firstByte[k] and lastByte[k] derived as follows:

$$firstByte [ k ] = {\sum }_{n = 1}^{k} ( sh \_entry \_point \_offset \_minus1 [ n - 1 ] + 1 )$$

$$lastByte [ k ] = firstByte [ k ] + sh \_entry \_point \_offset \_minus1 [ k ]$$

The last subset (with subset index equal to NumEntryPoints) consists of the remaining bytes of the coded slice data. When sps_entropy_coding_sync_enabled_flag is equal to 0, the value of NumEntryPoints shall be equal to 0. The subset shall consist of all coded bits of all CTUs in the slice. When sps_entropy_coding_sync_enabled_flag is equal to 1, each subset k with k in the range of 0 to NumEntryPoints, inclusive, shall consist of all coded bits of all CTUs in a CTU row within a slice, and the number of subsets (i.e., the value of NumEntryPoints+1) shall be equal to the total number of slice-specific CTU rows in the slice.

For some embodiments, below is a syntax table for slice data:

| | De- |
|---|---|
| | scriptor |
| slice_data( ) { | |
| FirstCtbRowInSlice = 1 | |
| for( i = 0; i < NumCtusInCurrSlice; i++ ) { | |
| CtbAddrInRs = CtbAddrInCurrSlice[ i ] | |
| CtbAddrX = ( CtbAddrInRs % PicWidthInCtbsY ) | |
| if (CtbAddrX = = CtbToSliceLeftBd[ i ] ) { | |
| NumHmvpCand = 0 | |
| NumHmvpIbcCand = 0 | |
| ResetIbcBuf = 1 | |
| } | |
| coding_tree_unit( ) | |
| if( i = = NumCtusInCurrSlice − 1 ) | |
| end_of_slice_one_bit /* equal to 1 */ | ae(v) |
| else if( CtbAddrX = = CtbToSliceRightBd[ CtbAddrX ] { | |
| if( sps_entropy_coding_sync_enabled_flag) | |
| end_of_subset_one_bit /* equal to 1 */ | ae(v) |
| byte_alignment( ) | |
| } | |
| FirstCtbRowInSlice = 0 | |
| } | |
| } | |
| } | |

The lists CtbToSliceLeftBd[CtbAddrX] and CtbToSliceRightBd[CtbAddrX] specifies the conversion from a horizontal CTB address to a left slice boundary in units of CTBs and to a right slice boundary in units of CTBs. The index ctbAddrX ranges from 0 to PicWidthInCtbsY, inclusive, where PicWidthInCtbsY is the width of the video picture specified in term of CTBs.

In some embodiments, for rectangular slices, the left and right boundaries are derived with the specified top-left CTU positions and width/height in units of CTUs of the slices; for raster scan slices, the left and right boundaries are derived as the left and right boundaries of the picture and CtbToSliceLeftBd[0]==(CtbAddrInCurrSlice[0]% PicWidthInCtbsY). For raster scan slices with rectangular shapes, CtbToSliceLeftBd [0]==0, indicating the left boundary of the picture. The lists CtbToSliceLeftBd[CtbAddrX, CtbAddrY] and CtbToSliceRightBd[CtbAddrX] for the left and right slice boundaries may be used for parallel processing, especially for wavefront parallel processing (WPP) in decoding process.

The lists CtbToSliceLeftBd[ctbAddrX] and CtbToSliceRightBd[ctbAddrX] specify the conversion from a horizontal CTB address of a slice to the left and right slice boundaries in units of CTBs. For some embodiments, the lists CtbToSliceLeftBd[CtbAddrX, CtbAddrY] and CtbToSliceRightBd[CtbAddrX] are derived as follows:

```
for( i = 0; i < NumCtusInCurrSlice; i++ ) {
  ctbAddrX0 = ( CtbAddrInCurrSlice[ 0 ] % PicWidthInCtbsY )
  ctbAddrX = ( CtbAddrInCurrSlice[ i ] % PicWidthInCtbsY )
  if( pps_rect_slice_flag = 1 ) { // rectangular slice
    ctbAddrXLz = ( CtbAddrInCurrSlice[ NumCtusInCurrSlice − 1 ] % PicWidthInCtbsY )
    CtbToSliceLeftBd[ ctbAddrX ] = ctbAddrX0
    CtbToSliceRightBd[ ctbAddrX ] = ctbAddrXz
  } else { // ( pps_rect_slice_flag = 0 ), raster scan slice
    ctbAddrY0 = ( CtbAddrInCurrSlice[ 0 ] / PicWidthInCtbsY )
    ctbAddrY = ( CtbAddrInCurrSlice[ i ] / PicWidthInCtbsY )
    CtbToSliceLeftBd[ ctbAddrX ] = ( ctbAddrY == ctbAddrY0 ) ? ctbAddrX0 : 0
    CtbToSliceRightBd[ ctbAddrX ] = PicWidthInCtbsY
  }
}
```

In some embodiments, when deriving the lists CtbToSliceLeftBd[CtbAddrX] and CtbToSliceRightBd[CtbAddrX] (including raster scan slices with rectangular shapes), a vertical CTB address does not apply to derivation of left boundaries. In some embodiments, for a rectangular slice (pps_rect_slice_flag=1), the left and right boundaries are derived with the top-left CTU and the last CTU positions of the slice in units of CTBs. For a raster scan slice (pps_rect_slice_flag=0), with a rectangular shape, the left and right boundaries are derived with the picture width in units of CTBs. For some embodiments, the lists CtbToSliceLeftBd[ctbAddrX] and CtbToSliceRightBd[ctbAddrX] specifies the conversion from a horizontal CTB address of a slice to the left and right slice boundaries in units of CTBs. Such CtbToSliceLeftBd and CtbToSliceRightBd are derived according to the following:

```
for( ctbAddrX = 0; ctbAddrX < PicWidthInCtbsY; ctbAddrX++ ) {
  if( pps_rect_slice_flag = 1 ) {
    ctbAddrX0 = ( CtbAddrInCurrSlice[ 0 ] % PicWidthInCtbsY )
    ctbAddrXLz = ( CtbAddrInCurrSlice[ NumCtusInCurrSlice − 1 ] % PicWidthInCtbsY )
    CtbToSliceLeftBd[ ctbAddrX] = ctbAddrX0
    CtbToSliceRightBd[ ctbAddrX ] = ctbAddrXz
  } else { // ( pps_rect_slice_flag = 0 )
    CtbToSliceLeftBd[ ctbAddrX] = 0
    CtbToSliceRightBd[ ctbAddrX ] = PicWidthInCtbsY
  }
}
```

### IV. Example Video Encoder

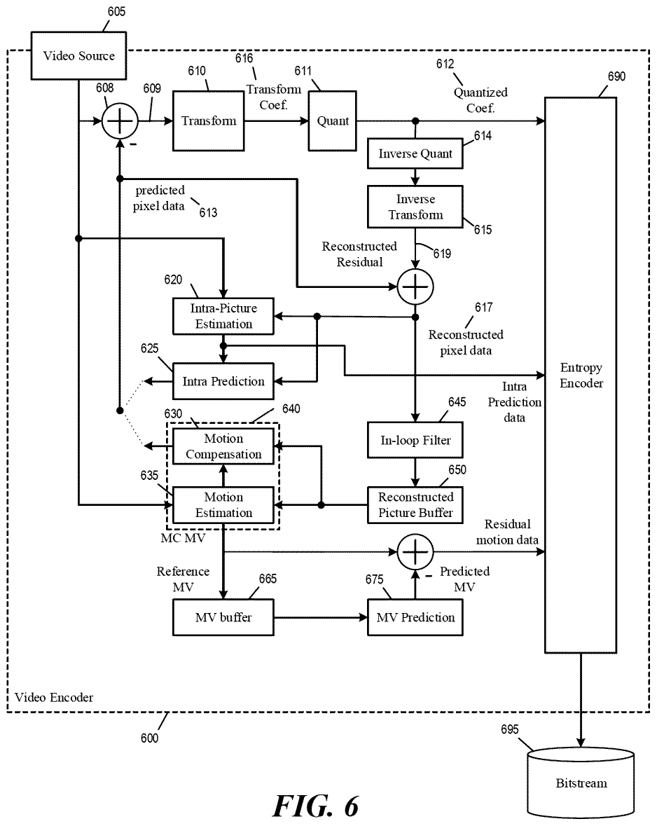

FIG. 6 illustrates an example video encoder 600 that may implement raster scan and rectangular slices. As illustrated, the video encoder 600 receives input video signal from a video source 605 and encodes the signal into bitstream 695. The video encoder 600 has several components or modules for encoding the signal from the video source 605, at least including some components selected from a transform module 610, a quantization module 611, an inverse quantization module 614, an inverse transform module 615, an intra-picture estimation module 620, an intra-prediction module 625, a motion compensation module 630, a motion estimation module 635, an in-loop filter 645, a reconstructed picture buffer 650, a MV buffer 665, and a MV prediction module 675, and an entropy encoder 690. The motion compensation module 630 and the motion estimation module 635 are part of an inter-prediction module 640.

In some embodiments, the modules 610-690 are modules of software instructions being executed by one or more processing units (e.g., a processor) of a computing device or electronic apparatus. In some embodiments, the modules 610-690 are modules of hardware circuits implemented by one or more integrated circuits (ICs) of an electronic apparatus. Though the modules 610-690 are illustrated as being separate modules, some of the modules can be combined into a single module.

The video source 605 provides a raw video signal that presents pixel data of each video frame without compression. A subtractor 608 computes the difference between the raw video pixel data of the video source 605 and the predicted pixel data 613 from the motion compensation module 630 or intra-prediction module 625 as prediction residual 609. The transform module 610 converts the difference (or the residual pixel data or residual signal 608) into transform coefficients (e.g., by performing Discrete Cosine Transform, or DCT). The quantization module 611 quantizes the transform coefficients into quantized data (or quantized coefficients) 612, which is encoded into the bitstream 695 by the entropy encoder 690.

The inverse quantization module 614 de-quantizes the quantized data (or quantized coefficients) 612 to obtain transform coefficients, and the inverse transform module 615 performs inverse transform on the transform coefficients to produce reconstructed residual 619. The reconstructed residual 619 is added with the predicted pixel data 613 to produce reconstructed pixel data 617. In some embodiments, the reconstructed pixel data 617 is temporarily stored in a line buffer (not illustrated) for intra-picture prediction and spatial MV prediction. The reconstructed pixels are filtered by the in-loop filter 645 and stored in the reconstructed picture buffer 650. In some embodiments, the reconstructed picture buffer 650 is a storage external to the video encoder 600. In some embodiments, the reconstructed picture buffer 650 is a storage internal to the video encoder 600.

The intra-picture estimation module 620 performs intra-prediction based on the reconstructed pixel data 617 to produce intra prediction data. The intra-prediction data is provided to the entropy encoder 690 to be encoded into bitstream 695. The intra-prediction data is also used by the intra-prediction module 625 to produce the predicted pixel data 613.

The motion estimation module 635 performs inter-prediction by producing MVs to reference pixel data of previously decoded frames stored in the reconstructed picture buffer 650. These MVs are provided to the motion compensation module 630 to produce predicted pixel data.

Instead of encoding the complete actual MVs in the bitstream, the video encoder 600 uses MV prediction to generate predicted MVs, and the difference between the MVs used for motion compensation and the predicted MVs is encoded as residual motion data and stored in the bitstream 695.

The MV prediction module 675 generates the predicted MVs based on reference MVs that were generated for encoding previously video frames, i.e., the motion compensation MVs that were used to perform motion compensation. The MV prediction module 675 retrieves reference MVs from previous video frames from the MV buffer 665. The video encoder 600 stores the MVs generated for the current video frame in the MV buffer 665 as reference MVs for generating predicted MVs.

The MV prediction module 675 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 695 by the entropy encoder 690.

The entropy encoder 690 encodes various parameters and data into the bitstream 695 by using entropy-coding techniques such as context-adaptive binary arithmetic coding (CABAC) or Huffman encoding. The entropy encoder 690 encodes various header elements, flags, along with the quantized transform coefficients 612, and the residual motion data as syntax elements into the bitstream 695. The bitstream 695 is in turn stored in a storage device or transmitted to a decoder over a communications medium such as a network.

The in-loop filter 645 performs filtering or smoothing operations on the reconstructed pixel data 617 to reduce the artifacts of coding, particularly at boundaries of pixel blocks. In some embodiments, the filtering or smoothing operations performed by the in-loop filter 645 include deblock filter (DBF), sample adaptive offset (SAO), and/or adaptive loop filter (ALF).

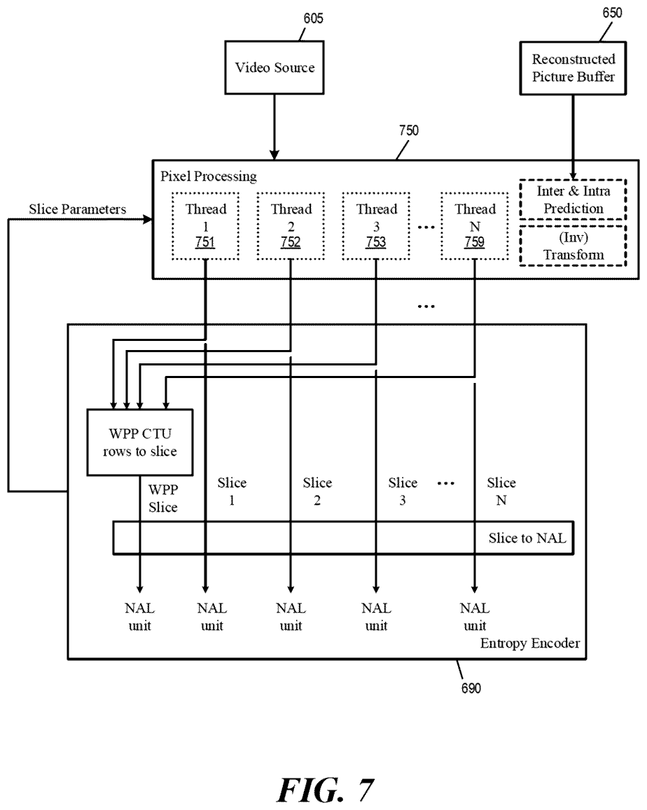

FIG. 7 illustrates portions of the video encoder 600 that implement parallel processing for rectangular and raster scan slices. The figure conceptually illustrates a pixel processing unit 750, which may include processing units that implements the prediction, transform, quantization, and filtering operations of the encoding loop, (e.g., modules 610, 611, 614, 615, 645, 650, 640, 625, 620). The pixel processing unit 750 is capable of parallel processing in multiple computing threads 751-759 (labeled 1 through N). The threads 751-759 perform encoding operations on the pixel data provided by the video source 605 into coded data to be transported. The encoding operations may be further based on pixel data provided by the reconstructed picture buffer 650.

The entropy encoder 690 may signal slice parameters to indicate whether the current picture is partitioned into rectangular or raster scan slices. The slice parameters may also include defining parameters of each slice (e.g., starting and ending CTUs, left and right boundaries, height and width, etc.). The slice parameters are inserted into the bitstream 695 as syntax elements and also provided to the pixel processing unit 750. Based on these slice parameters, the computing threads 751-759 are assigned different sets of CTUs of the current picture. The CTUs of different slices may be assigned to different threads 751-759. In some embodiments, when WPP is enabled, different rows of CTUs (of the same slice or different slices) may be assigned to different threads 751-759.

The data generated by the threads 751-759 are provided to the entropy encoder 690 to be transported or stored. Data from each slice is packaged as one NAL unit to be transported, regardless of whether the slice is rectangular or raster scan. When WPP is used, CTUs from different rows of a same slice may be collected and transported as one NAL unit.

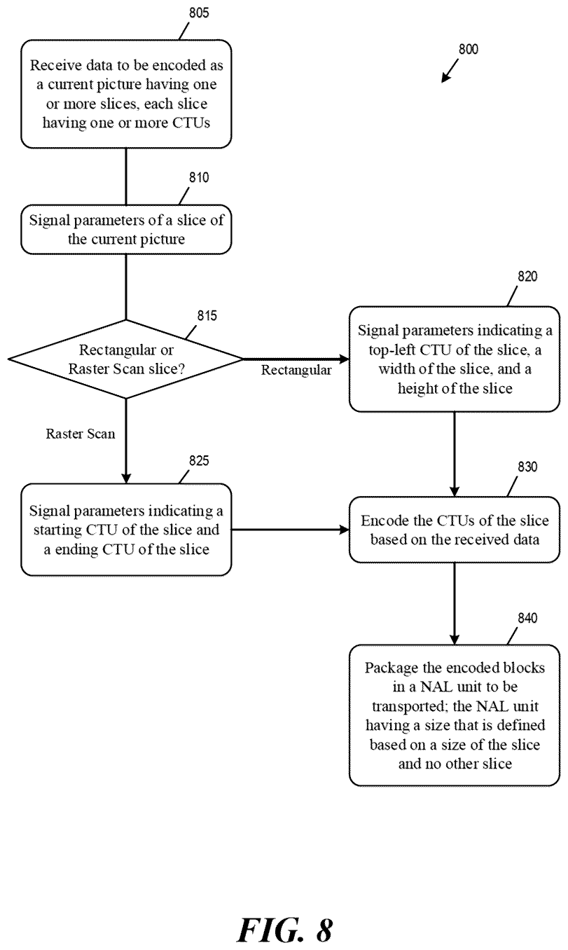

FIG. 8 conceptually illustrates a process 800 for encoding a video picture as rectangular or raster scan slices. In some embodiments, one or more processing units (e.g., a processor) of a computing device implementing the encoder 600 performs the process 800 by executing instructions stored in a computer readable medium. In some embodiments, an electronic apparatus implementing the encoder 600 performs the process 800.

The encoder receives (at block 805) data to be encoded as a current picture having one or more slices. Each slice includes one or more data blocks (e.g., CTUs.)

The encoder signals (at block 810) parameters of a slice of the current picture. The encoder determines (at block 815) whether the slice is a rectangular slice or raster scan slice. In some embodiments, the encoder may signal a flag as a syntax element (e.g., pps_rect_slice_flag) in a bitstream to indicate whether the slice is a rectangular slice or a raster scan slice. If the slice is (to be encoded as) a rectangular slice, the encoder signals (at block 820) parameters to indicate a top-left CTU of the slice, a width of the slice, and a height of the slice. If the slice is (to be encoded as) a raster scan slice, the encoder signals (at block 825) parameters to indicate a starting CTU of the slice and an ending CTU of the slice (but not width or height of the slice).

Then encoder encodes (at block 830) the CTUs of the slice based on the received data. The encoder may process the CTUs in two or more different slices of the current picture in parallel (simultaneously). The encoder may perform wavefront parallel processing (WPP) by processing different groups (e.g., rows) of CTUs of a slice in parallel with different delays. In some embodiments, the encoder may derive a right boundary and a left boundary for the slice based on the slice parameters. In some embodiments, when the slice is a raster scan slice, the right boundary of the slice is derived based on a width of the current picture, particularly when the raster scan slice is rectangular shaped. The current picture may also include rectangular slices that are adjacent but not aligned (e.g., slices 411 and 414).

The encoder packages (at block 840) the encoded blocks in a network abstraction layer (NAL) unit to be stored or transported. In some embodiments, the NAL unit has a size that is defined based on a size of the slice and no other slice. The NAL unit transports data for the slice and no other slice, and the different slices of the current picture are transported by different NAL units.

### V. Example Video Decoder

In some embodiments, an encoder may signal (or generate) one or more syntax element in a bitstream, such that a decoder may parse said one or more syntax element from the bitstream.

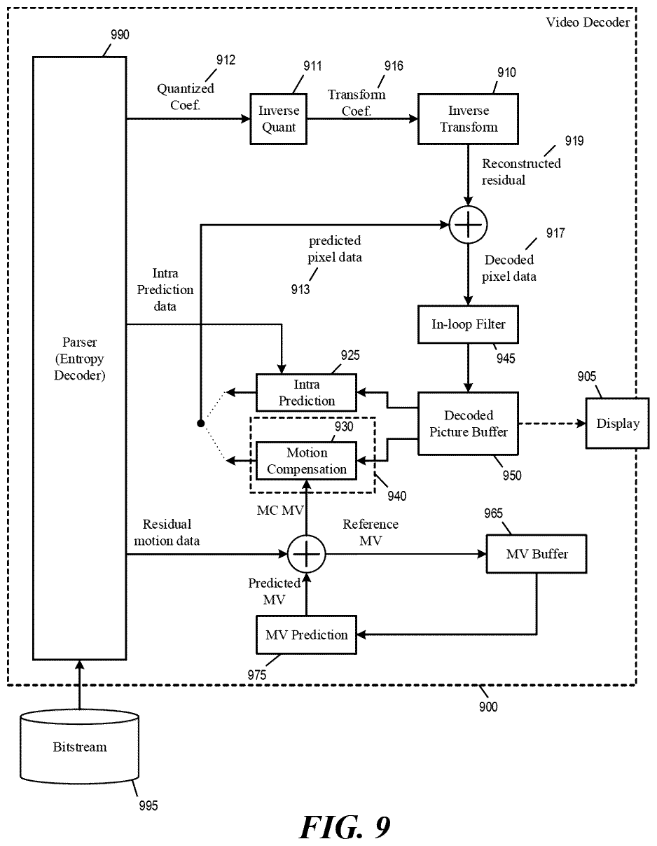

FIG. 9 illustrates an example video decoder 900 that may implement raster scan and rectangular slices. As illustrated, the video decoder 900 is an image-decoding or video-decoding circuit that receives a bitstream 995 and decodes the content of the bitstream into pixel data of video frames for display. The video decoder 900 has several components or modules for decoding the bitstream 995, including some components selected from an inverse quantization module 911, an inverse transform module 910, an intra-prediction module 925, a motion compensation module 930, an in-loop filter 945, a decoded picture buffer 950, a MV buffer 965, a MV prediction module 975, and a parser 990. The motion compensation module 930 is part of an inter-prediction module 940.

In some embodiments, the modules 910-990 are modules of software instructions being executed by one or more processing units (e.g., a processor) of a computing device. In some embodiments, the modules 910-990 are modules of hardware circuits implemented by one or more ICs of an electronic apparatus. Though the modules 910-990 are illustrated as being separate modules, some of the modules can be combined into a single module.

The parser 990 (or entropy decoder) receives the bitstream 995 and performs initial parsing according to the syntax defined by a video-coding or image-coding standard. The parsed syntax element includes various header elements, flags, as well as quantized data (or quantized coefficients) 912. The parser 990 parses out the various syntax elements by using entropy-coding techniques such as context-adaptive binary arithmetic coding (CABAC) or Huffman encoding.

The inverse quantization module 911 de-quantizes the quantized data (or quantized coefficients) 912 to obtain transform coefficients, and the inverse transform module 910 performs inverse transform on the transform coefficients 916 to produce reconstructed residual signal 919. The reconstructed residual signal 919 is added with predicted pixel data 913 from the intra-prediction module 925 or the motion compensation module 930 to produce decoded pixel data 917. The decoded pixels data are filtered by the in-loop filter 945 and stored in the decoded picture buffer 950. In some embodiments, the decoded picture buffer 950 is a storage external to the video decoder 900. In some embodiments, the decoded picture buffer 950 is a storage internal to the video decoder 900.

The intra-prediction module 925 receives intra-prediction data from bitstream 995 and according to which, produces the predicted pixel data 913 from the decoded pixel data 917 stored in the decoded picture buffer 950. In some embodiments, the decoded pixel data 917 is also stored in a line buffer (not illustrated) for intra-picture prediction and spatial MV prediction.

In some embodiments, the content of the decoded picture buffer 950 is used for display. A display device 905 either retrieves the content of the decoded picture buffer 950 for display directly, or retrieves the content of the decoded picture buffer to a display buffer. In some embodiments, the display device receives pixel values from the decoded picture buffer 950 through a pixel transport.

The motion compensation module 930 produces predicted pixel data 913 from the decoded pixel data 917 stored in the decoded picture buffer 950 according to motion compensation MVs (MC MVs). These motion compensation MVs are decoded by adding the residual motion data received from the bitstream 995 with predicted MVs received from the MV prediction module 975.

The MV prediction module 975 generates the predicted MVs based on reference MVs that were generated for decoding previous video frames, e.g., the motion compensation MVs that were used to perform motion compensation. The MV prediction module 975 retrieves the reference MVs of previous video frames from the MV buffer 965. The video decoder 900 stores the motion compensation MVs generated for decoding the current video frame in the MV buffer 965 as reference MVs for producing predicted MVs.

The in-loop filter 945 performs filtering or smoothing operations on the decoded pixel data 917 to reduce the artifacts of coding, particularly at boundaries of pixel blocks. In some embodiments, the filtering or smoothing operations performed by the in-loop filter 945 include deblock filter (DBF), sample adaptive offset (SAO), and/or adaptive loop filter (ALF).

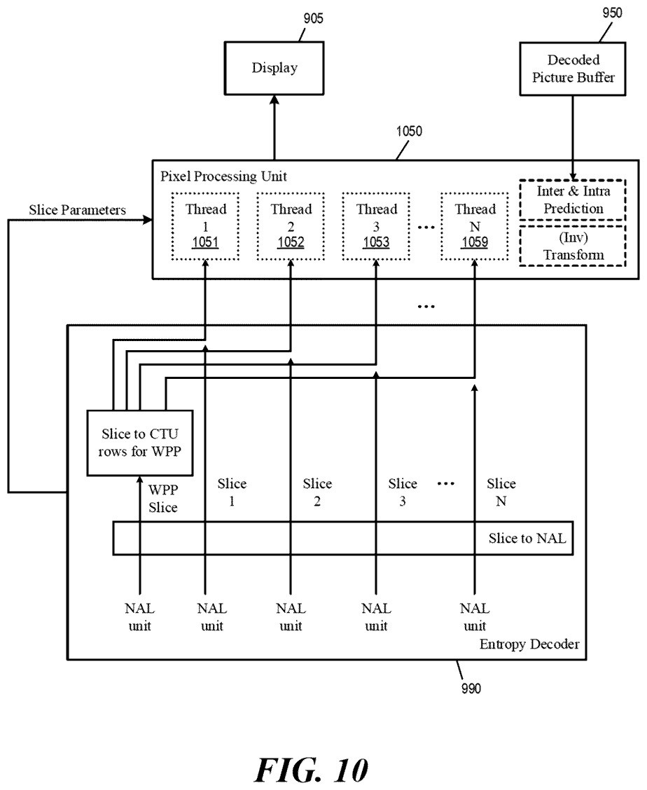

FIG. 10 illustrates portions of the video decoder 900 that implement parallel processing for rectangular and raster scan slices. The figure conceptually illustrates a pixel processing unit 1050, which may include processing units that implements the prediction, (inverse) transform, (inverse) quantization, and filtering operations of the decoding loop, (e.g., modules 911, 910, 945, 950, 940, 925). The pixel processing unit 1050 is capable of parallel processing in multiple computing threads 1051-1059 (labeled 1 through N). The threads 1051-1059 perform decoding operations on the coded video data provided by the entropy decoder 990 into pixel data for the display device 905. The decoding operations may be further based on pixel data provided by the decoded picture buffer 950.

The entropy decoder 990 may receive slice parameters to indicate whether the current picture is partitioned into rectangular or raster scan slices. The slice parameters may also include defining parameters of each slice (e.g., starting and ending CTUs, left and right boundaries, height and width, etc.). The entropy decoder 990 receives the slice parameters from the bitstream 995 as syntax elements and provide them to the pixel processing unit 1050. Based on these slice parameters, the computing threads 1051-1059 are assigned different sets of CTUs of the current picture. The CTUs of different slices may be assigned to different threads 1051-1059. In some embodiments, when WPP is enabled, different rows of CTUs (of the same slice or different slices) may be assigned to different threads 1051-1059.

The coded video data provided to the threads 1051-1059 are from NAL units in the bitstream 995. Data for each slice is packaged as one NAL unit for transport, regardless of whether the slice is rectangular or raster scan. When WPP is used, CTUs from different rows of a same slice may be collected and transported as one NAL unit.

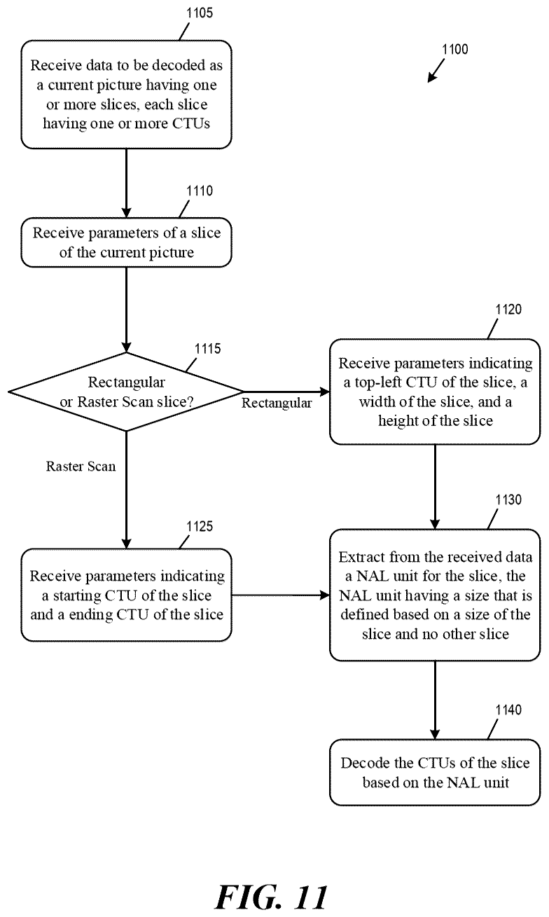

FIG. 11 conceptually illustrates a process 1100 for decoding a video picture as rectangular or raster scan slices. In some embodiments, one or more processing units (e.g., a processor) of a computing device implementing the decoder 900 performs the process 1100 by executing instructions stored in a computer readable medium. In some embodiments, an electronic apparatus implementing the decoder 900 performs the process 1100.

The decoder receives (at block 1105) data (e.g., bitstream of coded video) to be decoded as a current picture having one or more slices. Each slice includes one or more data blocks (e.g., CTUs.)

The decoder receives (at block 1110) parameters of a slice of the current picture. The decoder determines (at block 1115) whether the slice is a rectangular slice or raster scan slice. In some embodiments, the decoder may receive a flag from a syntax element (e.g., pps_rect_slice_flag) in a bitstream that indicates whether the slice is a rectangular slice or a raster scan slice. If the slice is (to be decoded as) a rectangular slice, the decoder receives (at block 1120) parameters to indicate a top-left CTU of the slice, a width of the slice, and a height of the slice. If the slice is (to be decoded as) a raster scan slice, the decoder signals (at block 1125) parameters to indicate a starting CTU of the slice and an ending CTU of the slice (but not width or height of the slice).

The decoder extracts (at block 1130) a network abstraction layer (NAL) unit that correspond to the slice from the received data (e.g., bitstream of coded video). In some embodiments, the NAL unit has a size that is defined based on a size of the slice and no other slice. The NAL unit transports data for the slice and no other slice, and the different slices of the current picture are transported by different NAL units.

Then decoder (at block 1140) the CTUs of the slice based on the NAL unit. The decoder may process the CTUs in two or more different slices of the current picture in parallel or simultaneously. The decoder may perform wavefront parallel processing (WPP) by processing different groups (e.g., rows) of CTUs of a slice in parallel with different delays. In some embodiments, the decoder may derive a right boundary and a left boundary for the slice based on the slice parameters. In some embodiments, when the slice is a raster scan slice, the right boundary of the slice is derived based on a width of the current picture, particularly when the raster scan slice is rectangular shaped. In some embodiments, the current picture may include rectangular slices that are adjacent but not aligned (e.g., slices 411 and 414). The decoded CTUs may then be provided for display as part of the reconstructed current picture.

### VI. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

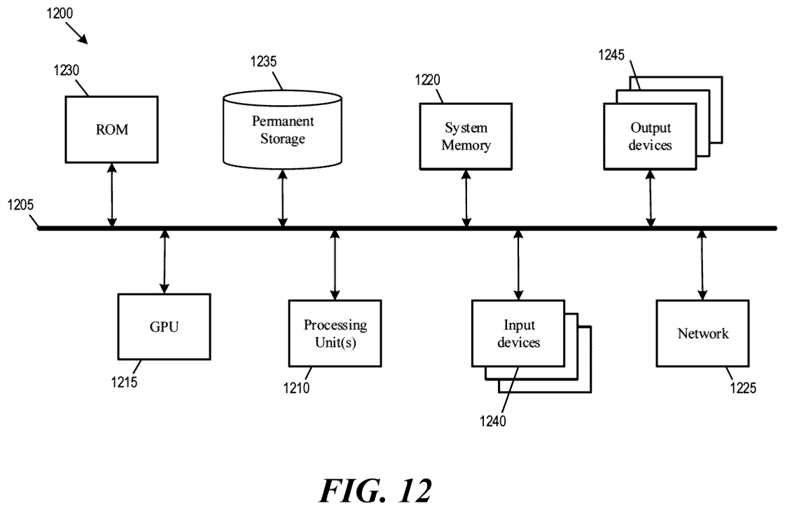

FIG. 12 conceptually illustrates an electronic system 1200 with which some embodiments of the present disclosure are implemented. The electronic system 1200 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1200 includes a bus 1205, processing unit(s) 1210, a graphics-processing unit (GPU) 1215, a system memory 1220, a network 1225, a read-only memory 1230, a permanent storage device 1235, input devices 1240, and output devices 1245.

The bus 1205 collectively represents all system, peripheral, and chipset buses that communicatively connect the numerous internal devices of the electronic system 1200. For instance, the bus 1205 communicatively connects the processing unit(s) 1210 with the GPU 1215, the read-only memory 1230, the system memory 1220, and the permanent storage device 1235.

From these various memory units, the processing unit(s) 1210 retrieves instructions to execute and data to process in order to execute the processes of the present disclosure. The processing unit(s) may be a single processor or a multi-core processor in different embodiments. Some instructions are passed to and executed by the GPU 1215. The GPU 1215 can offload various computations or complement the image processing provided by the processing unit(s) 1210.

The read-only-memory (ROM) 1230 stores static data and instructions that are used by the processing unit(s) 1210 and other modules of the electronic system. The permanent storage device 1235, on the other hand, is a read-and-write memory device. This device is a non-volatile memory unit that stores instructions and data even when the electronic system 1200 is off. Some embodiments of the present disclosure use a mass-storage device (such as a magnetic or optical disk and its corresponding disk drive) as the permanent storage device 1235.

Other embodiments use a removable storage device (such as a floppy disk, flash memory device, etc., and its corresponding disk drive) as the permanent storage device. Like the permanent storage device 1235, the system memory 1220 is a read-and-write memory device. However, unlike storage device 1235, the system memory 1220 is a volatile read-and-write memory, such a random access memory. The system memory 1220 stores some of the instructions and data that the processor uses at runtime. In some embodiments, processes in accordance with the present disclosure are stored in the system memory 1220, the permanent storage device 1235, and/or the read-only memory 1230. For example, the various memory units include instructions for processing multimedia clips in accordance with some embodiments. From these various memory units, the processing unit(s) 1210 retrieves instructions to execute and data to process in order to execute the processes of some embodiments.

The bus 1205 also connects to the input and output devices 1240 and 1245. The input devices 1240 enable the user to communicate information and select commands to the electronic system. The input devices 1240 include alphanumeric keyboards and pointing devices (also called “cursor control devices”), cameras (e.g., webcams), microphones or similar devices for receiving voice commands, etc. The output devices 1245 display images generated by the electronic system or otherwise output data. The output devices 1245 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 12, bus 1205 also couples electronic system 1200 to a network 1225 through a network adapter (not shown). In this manner, the computer can be a part of a network of computers (such as a local area network (“LAN”), a wide area network (“WAN”), or an Intranet, or a network of networks, such as the Internet. Any or all components of electronic system 1200 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 8 and FIG. 11) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video decoding method comprising:
receiving data to be decoded as a current picture comprising one or more slices, each slice comprising one or more coding tree units (CTUs);
receiving parameters of a slice of the current picture, the parameters comprising a top-left CTU of the slice, a width of the slice, and a height of the slice;
extracting a network abstraction layer (NAL) unit for the slice from the received data, the NAL unit having a size that is defined based on a size of the slice and no other slice; and
decoding the CTUs of the slice based on the NAL unit.

2. The video decoding method of claim 1, further comprising processing CTUs in two or more different slices of the current picture in parallel.

3. The video decoding method of claim 1, wherein different groups of CTUs of a slice are processed in parallel with different delays.

4. The video decoding method of claim 1, wherein the parameters specified are that of a rectangular slice.

5. The video decoding method of claim 4, wherein the current picture comprises at least two rectangular slices that are adjacent but not aligned.

6. The video decoding method of claim 1, further comprising receiving a flag to indicate whether the slice is a rectangular slice or a raster scan slice, wherein:
when the flag indicates that the slice is a raster scan slice, the slice parameters indicate a starting CTU of the slice and an ending CTU of the slice; and
when the flag indicates that the slice is a rectangular slice, the slice parameters indicate the top-left CTU of the slice, the width of the slice, and the height of the slice.

7. The video decoding method of claim 1, further comprising deriving a right boundary and a left boundary for the slice based on the slice parameters.

8. The video decoding method of claim 7, wherein when the slice is a raster scan slice, the right boundary of the slice is derived based on a width of the current picture.

9. The video decoding method of claim 1, wherein the NAL unit transports data for the slice and no other slice.

10. The video decoding method of claim 1, wherein the different slices of the current picture are transported by different NAL units.

11. A video encoding method comprising:
receiving data to be encoded as a current picture comprising one or more slices, each slice comprising one or more coding tree units (CTUs);
signaling parameters of a slice of the current picture, the parameters comprising a top-left CTU of the slice, a width of the slice, and a height of the slice;
encoding the CTUs of the slice based on the received data; and
packaging the encoded CTUs in a network abstraction layer (NAL) unit to be transported or stored, the NAL unit having a size that is defined based on a size of the slice and no other slice.

12. An electronic apparatus comprising:
a video encoder circuit configured to perform operations comprising:
receiving data to be encoded as a current picture comprising one or more slices, each slice comprising one or more coding tree units (CTUs);
signaling parameters of a slice of the current picture, the parameters comprising a top-left CTU of the slice, a width of the slice, and a height of the slice;
encoding the CTUs of the slice based on the received data; and
packaging the encoded CTUs in a network abstraction layer (NAL) unit to be transported or stored, the NAL unit having a size that is defined based on a size of the slice and no other slice.

13. An electronic apparatus comprising:
a video decoder circuit configured to perform operations comprising:
receiving data to be decoded as a current picture comprising one or more slices, each slice comprising one or more coding tree units (CTUs);
receiving parameters of a slice of the current picture, the parameters comprising a top-left CTU of the slice, a width of the slice, and a height of the slice;
extracting a network abstraction layer (NAL) unit for the slice from the received data, the NAL unit having a size that is defined based on a size of the slice and no other slice; and
decoding the CTUs of the slice based on the NAL unit.
